(19) United States
(12) Patent Application Publication
(10) Pub. No.: US 2008/0042950 A1
(43) Pub. Date: Feb. 21, 2008

(54) Display substrate and display device having the same

(75) Inventors: Haeng-Won Park, Seongnam-si (KR); Nam-Soo Kang, Ansan-si (KR); Yong-Soon Lee, Cheonan-si (KR); Min-Cheol Lee, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/703,414

(22) Filed: Feb. 6, 2007

(30) Foreign Application Priority Data
Feb. 7, 2006 (KR) 2006-11757

(51) Int. Cl. G09G 3/36

(52) U.S. Cl. 345/87

(57) ABSTRACT

A display substrate provides more reliable operation comprising a gate driver having groups of stages each connected to one end of each gate conductor of a respective group of gate conductors and groups of sub-gate drivers connected to the other end of the gate conductors of the respective groups of gate conductors, the gate drivers deliver driving signals to one end of the gate conductors of one group while the sub-gate drivers pull the other end of each of the gate conductors of the other group to a predetermined voltage.

### REFERENCE TO RELATED APPLICATION

This application claims priority by virtue of Korean Patent Application No. 2006-011757, filed on Feb. 7, 2006 and all the benefits accruing therefrom under 35 U.S.C. §119, the contents of which are hereby incorporated by reference.

### FIELD OF THE INVENTION

The present invention relates to a display substrate and a display device having the same, and more particularly, to a display substrate for improving the reliability of driving the display device.

### DESCRIPTION OF THE RELATED ART

Generally, a liquid crystal display (LCD) device includes an LCD panel and a driving device that delivers drive signals to the LCD panel. The LCD panel includes a thin film transistor (TFT) array substrate provided with a plurality of TFTs and a color filter (CF) substrate coupled with the TFT array substrate. The driving device includes a source circuit board, a data driving portion having a data driving chip and a gate driving portion for driving the plurality of gate lines formed in the TFT array substrate. Recently, the gate driving chip has been incorporated into the LCD panel resulting in enhanced productivity and as well as reducing the size of the LCD panel. It would be of great advantage to improve the reliability of the gate driving operation.

### SUMMARY OF THE INVENTION

In accordance with the present invention a display substrate includes a gate driver arrangement having greater reliability. The gate driver comprises a plurality of stages electrically connected to one end of the plurality of gate conductors, each of the even-numbered stages providing a gate signal to a corresponding one of the even-numbered gate conductors in response to a first clock signal and each of the odd-numbered stages providing a gate signals to a corresponding one of the odd-numbered gate conductors in response to a second clock signal which, advantageously, may be 180° out of phase with the first clock signal. When the even-numbered stages output their corresponding gate signals, respectively, in response to the second clock signal, each of the odd-numbered sub-gate drivers pulls down the level of the odd-numbered gate conductors, thus assuring that only the desired group of gate conductors are effectively energized and making the driving arrangement more reliable than in the prior art.

### BRIEF DESCRIPTION OF THE DRAWINGS

The above and other features and advantage points of the present invention will become more apparent from the ensuing description when read together with the drawing, in which:

FIG. 1 shows a plane view of a display device in accordance with an exemplary embodiment of the present invention;

FIG. 2 shows a plane view of a display device in accordance with another exemplary embodiment of the present invention;

FIG. 3 shows a block diagram illustrating the gate drivers and a sub-gate driver of a thin film transistor (TFT) array substrate of FIG. 1;

FIG. 4 shows a circuit diagram of one stage among a plurality of stages formed in the gate driver and the sub-gate driver of FIG. 3;

FIG. 5 shows a timing diagram illustrating an operation of the gate driver and the sub-gate driver of FIG. 4; and

FIG. 6 shows a timing diagram illustrating an operation of the sub-gate driver of FIG. 4.

### DESCRIPTION OF THE INVENTION

Hereinafter, the present invention will be explained in detail with reference to the accompanying drawings. In the drawings, some of the features may be exaggerated or an excessive number of certain features may not be shown for clarity. Like numerals refer to like elements throughout.

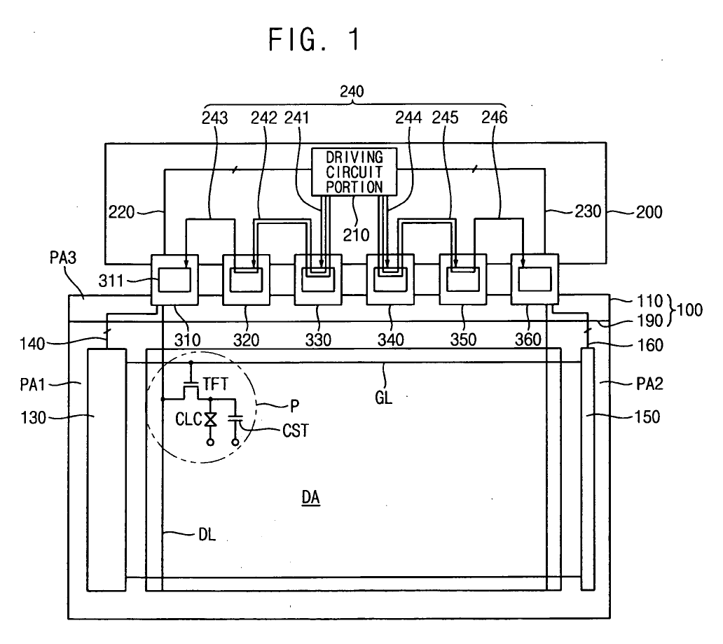

FIG. 1 shows a plane view of a display device in accordance with an exemplary embodiment of the present invention. The display device comprises a display panel 100, a source circuit board 200, and a plurality of data drivers 310, 320, 330, 340, 350, and 360. Display panel 100 comprises a TFT array substrate 110, a color filter substrate 190, and a liquid crystal layer (not shown) disposed between TFT array substrate 110 and CF substrate 190. Substrate 110 has a plurality of gate conductors GL (just one gate conductor shown in FIG. 1) arranged in a first direction and a plurality of source conductors DL (just one source conductor shown in FIG. 1) arranged in a second direction substantially perpendicular to the first direction.

Substrate 110 further comprises a display area DA and first, second, and third peripheral areas PA1, PA2, and PA3 surrounding display area DA. Display area DA has gate conductors GL and source conductors DL intersecting gate conductors GL, and pixel areas P (just one pixel shown in FIG. 1) are defined by gate conductors GL and source conductors DL. Each of pixel areas P comprises a switching element, such as TFT, a pixel electrode, and a storage capacitor CST.

The first peripheral area PA1 comprises gate drivers 130 each stage of which is electrically connected to one end of gate conductors GL and delivers a gate signal corresponding to each of gate conductors GL. Gate driver 130 outputs the gate signal to display panel 100 based on a first gate driving signal delivered through a first connecting conductor 140.

The second peripheral area PA2 comprises a sub-gate driver 150 which is electrically connected to the other end of gate conductors GL and pulls down to a predetermined low-level voltage, e.g., 0 volts, the gate signal applied to gate conductors GL. Sub-gate driver 150 pulls gate conductors GL down to the predetermined low-level-voltage the gate signal based on a second gate driving signal delivered through conductor 160.

Third peripheral area PA3 comprises pads (not shown) with a data source driving chip 311 mounted thereon. Data source driving chip 311 is formed on the first, second, third, fourth, fifth, and sixth data drivers, respectively, and outputs a data signal to each of data source conductors DL. In other words, the pads are electrically connected with an output terminal of each of data drivers 310, 320, 330, 340, 350, and 360.

Data source circuit board 200 is affixed to one end of display panel 100 and has a driving circuit 210. Driving circuit 210 outputs a driving signal for operating display panel 100 in response to an external signal externally provided. In other words, driving circuit 210 outputs the first gate driving signal provided to gate driver 130 and the second gate driving signal provided to sub-gate driver 150 to display panel 100. Further, driving circuit 210 outputs a data signal and a source driving signal to each of data drivers 310, 320, 330, 340, 350, and 360. Herein, the data signal represents R, G, B image data, for example and the source driving signal generally represents DE (data enable) signal, TP (data load) signal, STH signal, REV (reversal of polarity) signal, etc.

Data source circuit board 200 comprises a first signal conductor 220, a second signal conductor 230, and a signal conductor 240. Signal conductor 240 electrically connects driving circuit 210 with source driving chip 311 and comprises first, second, third, fourth, fifth, and sixth conductors 241, 242, 243, 244, 245, and 246.

First conductor 241 delivers a first data signal and a source driving signal to source driving chip 311 formed on data driver 330; the second conductor 242 delivers a second data signal and the source driving signal to the source driving chip 311 formed on data driver 320 through source driving chip 311 formed on data driver 330; and third conductor 243 delivers a third data signal and the source driving signal to source driving chip 311 formed on data driver 310 through source driving chips 311 formed on data drivers 320 and 330. fourth conductor 244 delivers a fourth data signal and the source driving signal to source driving chip 311 formed on data driver 340; fifth conductor 245 delivers a fifth data signal and the source driving signal to source driving chip 311 formed on data driver 350 through source driving chip 311 formed on data driver 340; and sixth conductor 246 delivers a sixth data signal and the source driving signal to source driving chip 311 formed on data driver 360 through source driving chips 311 formed on data drivers 340 and 350.

First signal conductor 220 delivers the first gate driving signal from driving circuit 210 to gate driver 130 through data driver 310. Second signal conductor 230 delivers the second gate driving signal from driving circuit 210 to sub-gate driver 150 through data driver 360. Herein, the first gate driving signal comprises a STV signal, a low-level voltage Vss, a first clock signal CK, a second clock signal CKB, for example and the second gate driving signal comprises the low-level voltage Vss, the first clock signal CK, and the second clock signal CKB, for example. It should be noted that data drivers 310, 320, 330, 340, 350, and 360 may be various types of a Tape Carrier Package (TCP), a Chip On Film (COF), and so on, for example.

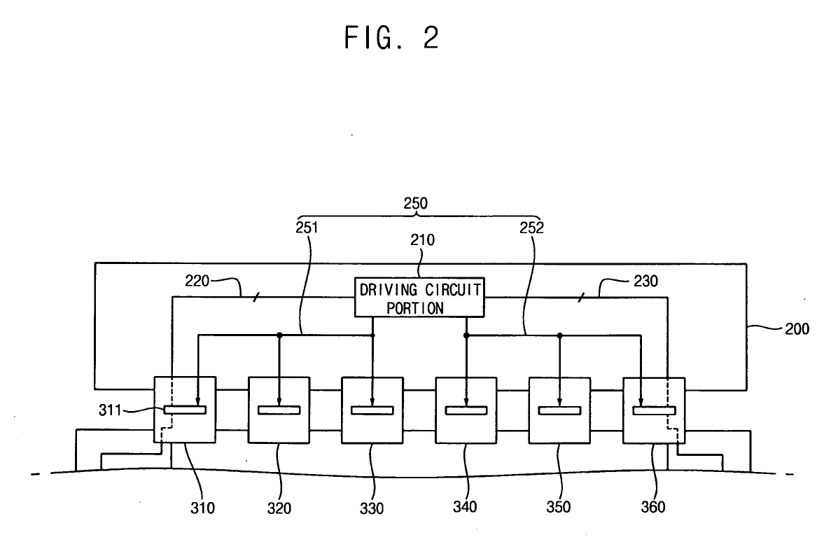

A display device according to another exemplary embodiment of the present invention will be now described with reference to FIG. 2. which has the same configuration as that of the display device of FIG. 1, except that signal conductor 250 is different from the signal conductor 240 of FIG. 1. Signal conductor 250 transmits a data signal and a source driving signal provided from the driving circuit 210 to the data drivers 310, 320, 330, 340, 350, and 360 through first and second common conductors 251, 252. In other words, the driving circuit 210 transmits first, second, and third data signal each corresponding to the first, second, and third data drivers 310, 320, and 330 through the first common conductor 251, and also transmits fourth, fifth, and sixth data signal each corresponding to the fourth, fifth, and sixth data drivers 340, 350, and 360 through the second common conductor 252. The first and second common conductors 251, 252 have a multi-drop structure, which means that the first, second, third, fourth, fifth, and sixth data signals and the source driving signal provided from the driving circuit 210 are sent to each of the data drivers 310, 320, 330, 340, 350 and 360 through the first and second common conductors 251, 252. Herein, although the first, second, third, fourth, fifth, and sixth data drivers are described, it should be noted that the data drivers are not limited to the number of the above data drivers but it is just for purpose of description.

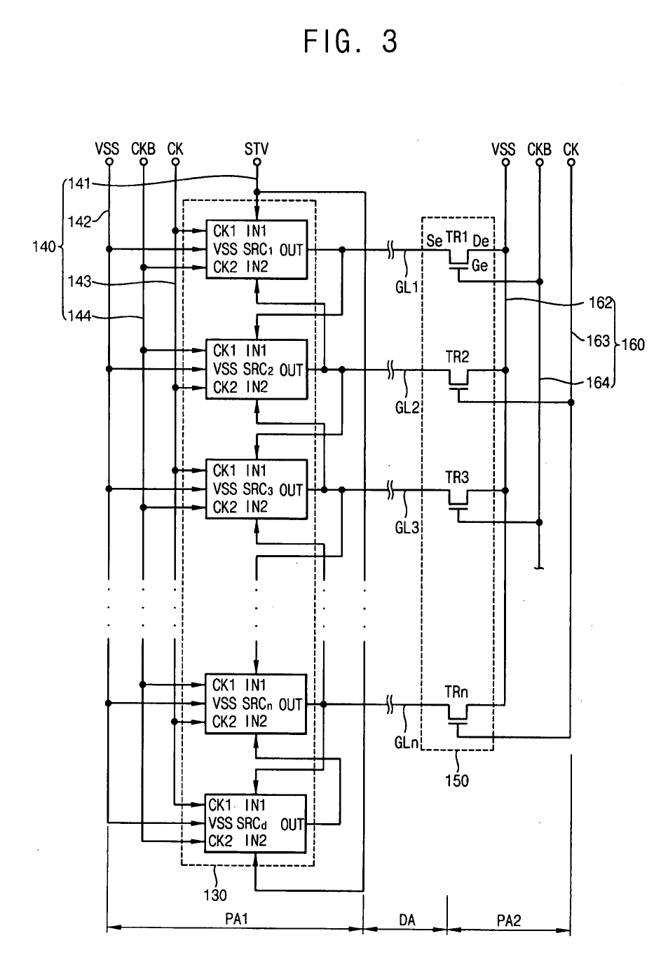

The configuration of the TFT array substrate 100 will be now described in more detail with reference to FIG. 3 which comprises gate driver 130 and the first connecting conductor 140 formed in the PA1, and the sub-gate driver 150 and the second connecting conductor 160 formed in the PA2.

Gate driver 130 comprises first, second, third, . . . , nth stages SRC1, SRC2, SRC3, . . . , SRCn corresponding to a plurality of the gate conductors GL1, GL2, . . . , GLn, respectively, and a dummy stage SRCd. The first, second, third, . . . , nth stages SRC1, SRC2, SRC3, . . . , SRCn and the dummy stage SRCd are electrically connected to one another. In other words, the second stage SRC2 has input terminals (e.g. 5 input terminals), and an output terminal. The input terminals of the second stage SRC2 comprise a first input terminal IN1 receiving an output signal of a previous stage (i.e. the first stage SRC1), a second input terminal IN2 receiving an output signal of a next stage (i.e. the third stage SRC3), a second clock terminal CK2 receiving a first clock signal CK, a first clock terminal CK1 receiving a second clock signal CKB, and a voltage terminal VSS receiving the low-level voltage Vss (i.e. a ground voltage). The output terminal OUT of the second stage SRC2 is electrically connected to a second gate conductor GL2 and delivers the gate signal to the second gate conductor GL2 formed in the display panel 100.

The remaining stages SRC3, . . . , SRCn have substantially the same configuration as that of the second stage SRC2 and thus a detailed description thereof will be omitted to avoid a duplication description.

Like the second, third, . . . , nth stages SRC2, SRC3, . . . , SRCn, the first stage SRC1 has input terminals (e.g. 5 input terminals) and an output terminal. The input terminals of the first stage SRC1 comprise a first input terminal IN1 receiving a STV signal, a second input terminal IN2 receiving an output signal of a next stage (i.e. the second stage SRC2), a second clock terminal CK2 receiving the second clock signal CKB, a first clock terminal CK1 receiving the first clock signal CK, and a voltage terminal VSS receiving the low-level voltage Vss (i.e. a ground voltage). The output terminal OUT of the first stage SRC1 is electrically connected to a first gate conductor GL1 and delivers the gate signal to the first gate conductor GL1 formed in the display panel 100.

The dummy stage SRCd has input terminals (e.g. 5 input terminals) and an output terminal. The input terminals of the dummy stage SRCd comprise a first input terminal IN1 receiving an output signal of a previous stage (i.e. the nth stage SRCn), a second input terminal IN2 receiving the STV signal, a second clock terminal CK2 receiving the second clock signal CKB, a first clock terminal CK1 receiving the first clock signal CK, and a voltage terminal VSS receiving the low-level voltage Vss (i.e. a ground voltage). The output terminal OUT of the dummy stage SRCd delivers substantially the same output signal as that of the first to nth stages SRC1 to SRCn to the input terminal IN2 of the previous stage (i.e. the nth stage SRCn).

The first connecting conductor 140 delivers the first gate driving signal to the input terminals, for example, the first input terminal CK1, the second input terminal CK2, and the voltage terminal VSS of each of the first, second, . . . , nth stages SRC1, SRC2, SRC3, . . . , SRCn. The first connecting conductor 140 comprises a first conductor 141, a first voltage conductor 142, a first clock conductor 143, and a second clock conductor 144.

First conductor 141 delivers the STV signal to the first input terminal IN1 of the first stage SRC1 and the second input terminal IN2 of the dummy stage SRCd, respectively. The first voltage conductor 142 delivers the low-level voltage Vss to the voltage terminal VSS of each of the first, second, third, . . . , nth stages SRC1, SRC2, SRC3, . . . , SRCn, and the dummy stage SRCd.

The first clock conductor 143 delivers the first clock signal CK to the first clock terminal CK1 of each of the odd-numbered stages SRC1, SRC3, . . . SRCn−1, the dummy stage SRCd, and the second clock terminal CK2 of each of the even-numbered stages SRC2, SRC4, . . . , SRCn.

The second clock conductor 144 delivers the second clock signal CKB to the first clock terminal CK1 of each of the even-numbered stage SRC2, SRC4, . . . , SRCn, the second clock terminal CK2 of each of the odd-numbered stages SRC1, SRC3, . . . , SRCn−1 and the dummy stage SRCd.

The sub-gate driver 150 comprises first, second, third, . . . , nth discharge elements TR1, TR2, TR3, . . . , TRn electrically connected to first, second, third, . . . , nth gate conductors GL1, GL2, . . . , GLn, respectively.

The first discharge element TR1 comprises a gate electrode Ge receiving the second clock signal CKB, a source electrode Se receiving the output signal of the first stage SRC1, and a drain electrode De receiving a ground voltage Vss. Herein, the first stage SRC1 outputs its gate signal in response to the first clock signal CK, and the second stage SRC2 outputs its gate signal in response to the second clock signal CKB. Specifically, the odd-numbered stages SRC1, SRC3, . . . , SRCn−1 output their corresponding gate signals, respectively, in response to the first clock signal CK.

When the even-numbered stages SRC2, SRC4, . . . , SRCn output their corresponding gate signals, respectively, in response to the second clock signal CKB, each of the odd-numbered discharge elements TR1, TR3, TRn−1 pulls down the level of its gate signal delivered from each of the odd-numbered gate conductors GL1, GL3, . . . , GLn−1 in response to the second clock signal CKB.

Each of the even-numbered discharge elements TR2, TR4, . . . , TRn also pulls down the level of its gate signal delivered from each of the even-numbered gate conductors GL2, GL4, . . . , GLn in response to the first clock signal CK.

The second connecting conductor 160 comprises a second voltage conductor 162, a third clock conductor 163, and a fourth clock conductor 164. The second voltage conductor 162 delivers the ground voltage Vss to the drain electrode De of each of the discharge elements TR1, TR2, . . . , TRn. The third clock conductor 163 delivers the first clock signal CK to the gate electrode Ge of each of the even-numbered discharge elements TR2, TR4, . . . , TRn. The fourth clock conductor 164 delivers the second clock signal CKB to the gate electrode Ge of each of the odd-numbered discharge elements TR1, TR3, . . . , TRn−1. Herein, it should be noted that the first and second clock signals CK and CKB may be in turn applied to the first and second input terminals CK1 and CK2.

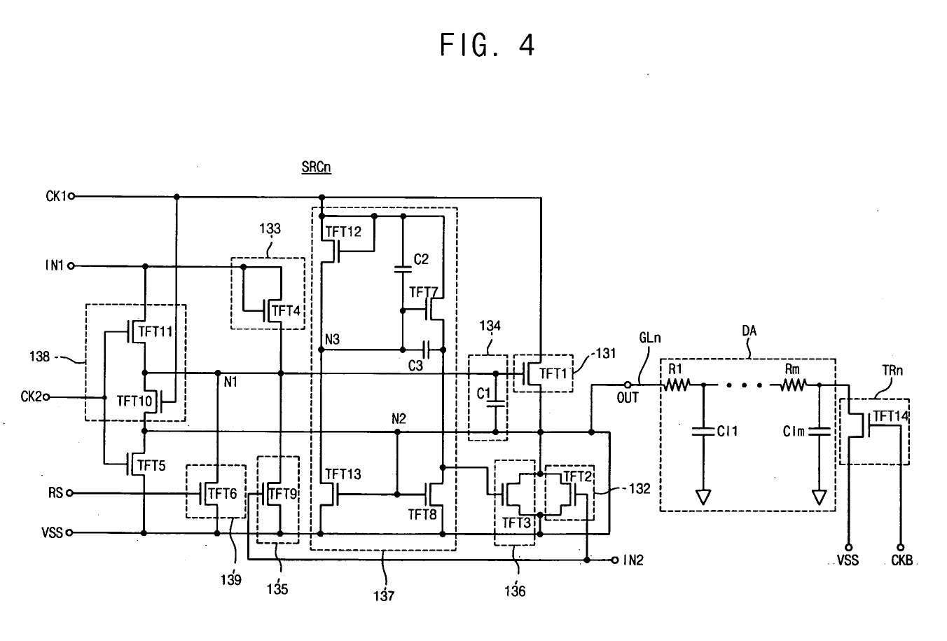

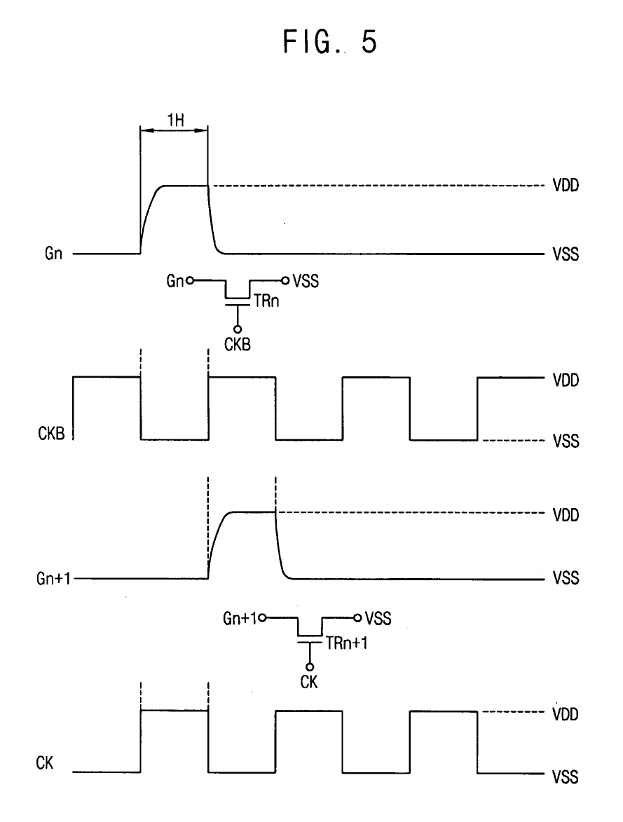

The operation of the nth stage SRCn will be now described in more detail with reference to FIGS. 4 and 5. FIG. 4 shows a circuit diagram of one stage among a plurality of stages formed in the gate driver and the sub-gate driver of FIG. 3, and FIG. 5 shows a timing diagram illustrating the operation of the gate driver and the sub-gate driver of FIG. 4.

Referring to FIG. 4, the nth stage SRCn comprises a pull-up 131 pulling up the output signal GLn in response to the first clock signal CK, and a pull-down 132 pulling down the output signal GLn in response to the output signal G(n+1) of a (n+1)th stage.

The pull-up 131 comprises a first transistor TFT1 with a gate electrode electrically connected to a first node N1, a source electrode electrically connected to the first clock terminal CK1, and a drain electrode electrically connected to the output terminal OUT. The pull-down 132 comprises a second transistor TFT2 with a gate electrode electrically connected to the second input terminal IN2 of the (n+1)th stage, a drain electrode electrically connected to the output terminal OUT, and a source electrode electrically connected to a ground voltage Vss.

The nth stage SRCn further comprises a pull-up driver which turns on the pull-up 131 in response to the output signal G(n−1) of a previous stage (i.e. the (n−1)th stage SRC(n−1)) and turns off the pull-up 131 in response to the output signal G(n+1) of the next stage (i.e. the (n+1)th stage SRC(n+1)). The pull-up driver comprises a buffer 133, a charging 134, and a first discharging 135.

The buffer 133 comprises a fourth transistor TFT4 with a gate electrode and a drain electrode electrically connected to the first input terminal IN1 in common, and a source electrode electrically connected to the first node N1. The charging 134 comprises a first capacitor C1 with a first electrode electrically connected to the first node N1 and a second electrode electrically connected to the second node N2. The first discharging 135 comprises a ninth transistor TFT9 with a gate electrode electrically connected to the second input terminal IN2 of the (n+1)th stage SRC(n+1), a drain electrode electrically connected to the first node N1, and a source electrode electrically connected to the voltage terminal VSS.

The nth stage SRCn further comprises a holding 136 holding the output signal Gn to the ground voltage Vss, and a switching 137 controlling an operation of the holding 136. The holding 136 comprises a third transistor TFT3 with a gate electrode electrically connected to the third node N3, a drain electrode electrically connected to the second node N2, and a source electrode electrically connected to the voltage terminal VSS. The switching 137 comprises seventh, eighth, twelfth, and thirteenth transistors TFT7, TFT8, TFT12, and TFT13, and second and third capacitors C2, C3.

The gate and drain electrodes of the twelfth transistor TFT12 are electrically connected to the first clock terminal CK1 altogether and the source electrode of the twelfth transistor TFT12 is electrically connected to the third node N3. The drain electrode of the seventh transistor TFT7 is electrically connected to the first clock terminal CK1; the gate electrode of the seventh transistor TFT7 is electrically connected to the first clock terminal CK1 through the second capacitor C2; and the source electrode of the seventh transistor TFT7 is electrically connected to the third node N3 through a third capacitor C3. The third capacitor C3 is disposed between the gate electrode and the source electrode of the seventh transistor TFT7.

The gate electrode of the thirteenth transistor TFT13 is electrically connected to the second node N2; the drain electrode of the thirteenth transistor TFT13 is electrically connected to the source electrode of the twelfth transistor TFT12; and the source electrode of the twelfth transistor TFT12 is electrically connected to the voltage terminal VSS. The gate electrode of the eighth transistor TFT8 is electrically connected to the second node N2; the drain electrode of the eighth transistor TFT8 is electrically connected to the drain electrode of the seventh transistor TFT7; and the source electrode of the eighth transistor TFT8 is electrically connected to the voltage terminal VSS.

The nth stage SRCn further comprises a ripple prevention 138 and a reset 139. The ripple prevention 138 comprises tenth and eleventh transistors TFT10, TFT11. The gate electrode of the tenth transistor TFT10 is electrically connected to the first clock terminal CK1; the drain electrode of the tenth transistor TFT10 is electrically connected to the source electrode of the eleventh transistor TFT11; and the source electrode of the tenth transistor TFT10 is electrically connected to the second node N2. The gate electrode of the eleventh transistor TFT11 is electrically connected to the second clock terminal CK2 and receives the second clock signal CKB.

The reset 139 comprises a sixth transistor TFT6 with a gate electrode electrically connected to the reset terminal RS receiving the output signal Gn of the nth stage SRCn, a drain electrode electrically connected to the first node N1, and a source electrode electrically connected to the voltage terminal VSS.

The nth discharging element TRn comprises a fourteenth transistor TFT14 with a gate electrode receiving the second clock signal CKB; the source electrode electrically connected to the nth gate conductor GLn; and the drain electrode electrically connected to the voltage terminal VSS.

When the nth stage SRCn outputs the output signal Gn to the nth gate conductor GLn in response to the first clock signal CK, the fourteenth transistor TFT14 discharges the output signal Gn delivered to the nth gate conductor GLn to the ground voltage Vss in response to the second clock signal CKB.

A display area (DA) represents an equivalent circuit of the LCD panel 100 (see FIG. 1). In other words, the display area (DA) comprises a plurality of resistors R1, . . . , Rm and a plurality of capacitors Cl1, . . . , Clm considering a plurality of elements (not shown) formed in the LCD panel 100.

Referring to FIG. 5, the nth stage SRCn outputs the nth gate signal Gn in response to the first clock signal CK. The nth gate signal Gn is applied to the nth gate conductor GLn and activates the liquid crystal capacitors Cl1, . . . , Clm (see FIG. 4) so as to charge a desired pixel voltage therein.

The nth gate signal Gn is applied to the source electrode of the nth discharging element TRn. Meanwhile, the gate electrode of the nth discharging element TRn receives the second clock signal CKB different from the phase of the first clock signal CK, such as, but not limited to, a 180° phase difference between the first and second clock signals CK, CKB. The nth discharging element TRn discharges the nth gate signal Gn applied to the source electrode to the ground voltage Vss in response to the second clock signal CKB. In other words, since the second clock signal CKB is a clock signal of a constant period, the nth discharging element TRn continues to discharge a voltage left in the nth gate conductor GLn to the ground voltage Vss and thus improves stability of the operation of the liquid crystal capacitors Cl1, . . . , Clm electrically connected to the nth gate conductor GLn.

Meanwhile, the (n+1) th stage SRC(n+1) outputs a (n+1)th gate signal G(n+1) in response to the second clock signal CKB. The (n+1) th gate signal G(n+1) is applied to the gate conductor GL(n+1) and activates the liquid crystal capacitors Cl1, . . . , Clm so as to charge a desired pixel voltage therein.

Then, the (n+1)th gate signal G(n+1) is applied to the source electrode of the (n+1)th discharging element TR(n+1). Meanwhile, the gate electrode of the (n+1)th discharging element TR(n+1) receives the first clock signal CK different from the phase of the second clock signal CKB, such as, but not limited to, a 180° phase difference between the first and second clock signals CK, CKB. In this configuration, the (n+1)th discharging element TR(n+1) discharges the (n+1)th gate signal G(n+1) applied to the source electrode to the ground voltage Vss in response to the first clock signal CK. In other words, since the first clock signal CK is a clock signal of a constant period, the nth discharging element TRn continues to discharge a voltage left in the (n+1)th gate conductor GL(n+1) to the ground voltage Vss and thus improves stability of the operation of the liquid crystal capacitors Cl1, . . . , Clm electrically connected to the (n+1)th gate conductor GL(n+1).

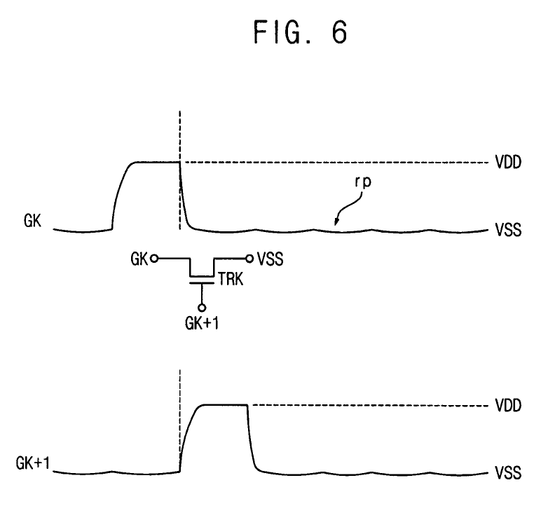

FIG. 6 shows a timing diagram illustrating the operation of the sub-gate driver 160 of FIG. 4. Referring to FIG. 6, a Kth discharging element TRK comprises a gate electrode electrically connected to a (K+1)th gate conductor, a drain electrode electrically connected to a Kth gate conductor, and a source electrode electrically connected to the voltage terminal VSS. The Kth discharging element TRK discharges the Kth gate signal GK to the ground voltage Vss in response to the (K+1)th gate signal delivered through the (K+1)th gate conductor.

Since the (K+1)th gate signal applied to the gate electrode of the Kth discharging element TRK is delivered through the (K+1)th gate conductor, resistance and capacitance of the (K+1)th gate conductor cause deterioration of the (K+1)th gate signal. The Kth discharging element TRK generates a leakage current by the (K+1)th gate signal G(K+1) and thus a signal noise is introduced in the Kth gate signal GK. As a result, the liquid crystal capacitor driven by the Kth gate signal GK with the signal noise may be unstably operated.

According to the exemplary embodiments of the present invention, the first or second clock signals CK or CKB of the gate driver 130 generate the gate signal each corresponding to the gate conductors without any signal noise. Further, the gate driver 130 and the sub-gate driver 160 improve reliability of the gate signal each corresponding to the gate conductors. In other words, a control signal not influenced by resistance and capacitance of each of the gate conductors may stably generate the gate signal each corresponding to the gate conductors.

What has been described is illustrative of the principles of the invention, various modifications may be apparent to those skilled in the art and may be made without, however, departing from the spirit and scope of thereof.

What is claimed is:

1. A display substrate comprising:
a plurality of data conductors;
a plurality of gate conductors intersecting the data conductors;
gate drivers electrically connected to one end of the gate conductors and delivering a gate signal corresponding to each of the gate conductors in response to at least one of a first clock signal and a second clock signal; and
a sub-gate driver electrically connected to the other end of the gate conductors and pulling down a voltage level of the gate signal to a desired voltage in response to at least one of the first clock signal and the second clock signal.

2. The display substrate of claim 1, wherein the sub-gate driver comprises a plurality of discharging elements electrically connected to the gate conductors; and
wherein each of the discharging elements comprises a gate electrode receiving the first clock signal or the second clock signal, a drain electrode receiving the desired voltage, and a source electrode receiving the gate signal.

3. The display substrate of claim 2, wherein the desired voltage is a ground voltage.

4. The display substrate of claim 2, wherein the first clock signal has a 800° phase difference from the second clock signal.

5. The display substrate of claim 2, wherein the gate driver comprises a plurality of stages electrically connected to the one end of the gate conductors, and each of the stages outputs a gate signal corresponding to each of the gate conductors.

6. The display substrate of claim 5, wherein each of odd-numbered stages outputs an odd-numbered gate signal through an odd-numbered gate conductor in response to the first clock signal; and
wherein each of even-numbered stages outputs an even-numbered gate signal through an even-numbered gate conductor in response to the second clock signal.

7. The display substrate of claim 2, wherein each of the odd-numbered discharging elements pulls down an odd-numbered gate signal to the desired voltage in response to the second clock signal; and
wherein each of the even-numbered discharging elements pulls down an even-numbered gate signal to the desired voltage in response to the first clock signal.

8. The display substrate of claim 1, further comprising a first connecting conductor and a second connecting conductor,
wherein the first connecting conductor delivers the first and second clock signals and a desired signal to the gate driver, and the second connecting conductor delivers the first and second clock signals and the desired signal to the sub-gate driver.

9. The display substrate of claim 8, wherein the desired signal has a ground voltage.

10. A display substrate comprising:
a plurality of data conductors;
a plurality of gate conductors intersecting the data conductors;
gate drivers electrically connected to one end of the gate conductors and delivering a gate signal corresponding to each of the gate conductors in response to at least one of a first clock signal and a second clock signal, and a third signal; and
a sub-gate driver electrically connected to the other end of the gate conductors and pulling down a voltage level of the gate signal to a desired voltage in response to at least one of the first clock signal and the second clock signal, and the third signal.

11. The display substrate of claim 10, wherein the sub-gate driver comprises a plurality of discharging elements with a gate electrode electrically connected to the first clock or the second clock; a source electrode electrically connected to the gate signal; and a drain electrode electrically connected to the desired voltage.

12. The display substrate of claim 11, wherein a voltage level of the third signal and the desired voltage is a ground voltage.

13. A display device comprising:
a display panel having a plurality of pixels; gate drivers formed on one end of the display panel and delivering a gate signal; and a sub-gate driver formed on the other end of the display panel for pulling the gate signal to a desired voltage;
a source circuit board comprising a driving circuit, a first signal conductor, and a second signal conductor, the first signal conductor delivering a first gate driving signal and a third signal to the gate driver and the second signal conductor delivering a second gate driving signal and the third signal to the sub-gate driver; and
a data driver electrically connecting the source circuit board with the display panel and delivering the first and second gate driving signals, and the third signal to the gate driver and the sub-gate driver, respectively.

14. The display device of claim 13, wherein the data driver receives the first gate driving signal and the third signal through the first signal conductor and delivers the first gate driving signal and the third signal to the gate driver,
wherein the data driver receives the second gate driving signal and the third signal through the second signal conductor and delivers the second gate driving signal and the third signal to the sub-gate driver.

15. The display device of claim 14, wherein the display panel further comprises a first connecting conductor and a second connecting conductor the first connecting conductor delivering the first gate driving signal and the third signal to the gate driver, and the second connecting conductor delivering the second gate driving signal and the third signal to the sub-gate driver.

16. The display device of claim 15, wherein the first clock signal has a 180 phase difference from the second clock signal.

17. The display device of claim 16, wherein a voltage level of the third signal and the desired voltage is a ground voltage.

18. The display device of claim 14, wherein the data driver is one type of a tape carrier package (TCP), a chip on film (COF), and a chip on glass (COG).

19. A display substrate comprising:
a plurality of data conductors;
a plurality of gate conductors intersecting the data conductors;
groups of gate drivers electrically connected to one end of the gate conductors;
groups of sub-gate drivers electrically connected to the other end of the gate conductors; and
driving circuitry for delivering a gate signal to the gate drivers connected to a first group of the gate conductors while simultaneously delivering a signal to each of a group of sub-gate drivers connected to a different group of gate conductors, said driving circuitry delivering a gate signal to the gate drivers connected to a second group of the gate conductors while simultaneously delivering a signal to each of a group of sub-gate drivers connected to the first group of gate conductors.

20. A method of operating gate drivers that drive gate conductors of a display unit, comprising
grouping stages of the gate drivers so that the gate drivers of a first group are each connected to one end of each gate conductor of a first group of gate conductors and so that the gate drivers of a second group are each connected to one end of each gate conductor of a second group of gate conductors;
grouping a plurality of sub-gate drivers so that the sub-gate drivers of a first group are connected to the other end of the gate conductors of the second groups of gate conductors and so that the sub-gate drivers of a second group are connected to the other end of the gate conductors of the first groups of gate conductors, and
causing the gate drivers of the first group to deliver driving signals to one end of the gate conductors of the first group while the sub-gate drivers pull the other end of the gate conductors of the second group to a predetermined voltage.
